(19) United States
(12) Patent Application Publication
(10) Pub. No.: US 2026/0036016 A1
(43) Pub. Date: Feb. 5, 2026

(54) COMPOSITIONS AND METHODS FOR FLUID LOSS CONTROL IN A SUBTERRANEAN FORMATION

(71) Applicant: ChampionX LLC, Sugar Land, TX (US)

(72) Inventors: Tzu-Ping Hsu, Katy, TX (US); Maria Celeste Tria, Houston, TX (US); Victor Keasler, Richmond, TX (US); Chad Gilmer, Richmond, TX (US); Vittoria Balsamo, Fulshear, TX (US); Jesse Lee, Sugar Land, TX (US)

(21) Appl. No.: 19/276,070

(22) Filed: Jul. 22, 2025

Related U.S. Application Data
(60) Provisional application No. 63/677,514, filed on Jul. 31, 2024.

(51) Int. Cl. E21B 33/138; C09K 8/46; E21B 43/267

(52) U.S. Cl. CPC E21B 33/138; C09K 8/46; E21B 43/267

(57) ABSTRACT

Methods of treating drilled or fractured subterranean formations include the steps of packing at least a portion of the subterranean formation with a packing composition to form a packed subterranean formation; and applying a sealing composition to the packed subterranean formation to form a treated subterranean formation. Alternatively, a packing composition is mixed with a sealing composition to form a reactive composition, and the reactive composition is applied to at least a portion of the subterranean formation to form a treated subterranean formation. The reactive compositions cure within the treated subterranean formations to provide sealed subterranean formations.

### BACKGROUND

“Plug and abandonment” (P&A) is a term of art referring to processes in the oil and gas industry to seal non-producing petroleum wells, thereby mitigating environmental risks, ensuring safety, and complying with applicable regulations, and thereby managing resources effectively for present and future generations. P&A is a critical component of the overall lifecycle management of oil and gas assets.

The P&A process involves retrieval of production equipment from the well and removal of wellhead and associated infrastructure, in addition to sealing the well. Conventionally, cement plugs are placed at various depths within the wellbore to isolate and seal off different zones of the well. The well is then capped with a sealing device called a wellhead plug to prevent the migration of fluids between different geological formations proximal to the well.

The criticality of P&A in the oil and gas industry is attributable to several factors related to environmental protection and safety and risk mitigation. Abandoned wells that are not sufficiently sealed can leak hydrocarbons, brine, or other harmful fluids (gases and liquids) into groundwater or surface water, as well as surrounding soil and air, leading to contamination of surrounding air, water, and/or soil with hazardous or even toxic materials and associated ecological damage. Migration of subterranean fluids between different geological formations proximal to the well can lead to contamination of ground water or soil in locations remote to the well. Insufficiently sealed wells can also lead to the uncontrolled release of hydrocarbons or the potential for blowouts, with the concomitant and risk of explosions and fires.

By performing P&A activities, the industry mitigates the foregoing risks and ensures the safety of workers as well as nearby communities, infrastructure, and ecology.

Despite the understood criticality of P&A in the oil and gas industry, many problems exist with respect to availability of P&A services, and also with the quality and thereby efficacy of the seal placed by such services. The expertise, tools, and materials required for P&A of conventional petroleum wells are drastically different from those required for shale gas wells, and even many qualified service providers are not familiar with the P&A requirements of both types of wells. Exacerbating the problem, the global supply of P&A service providers at the time of this writing is fragmented and unable to meet demand cost-effectively. And market pressure to seal more wells for less money has created a culture of shortcuts and unsafe P&A work practices, resulting in insufficient sealing of wells on a global scale.

The foregoing problems present an opportunity for improving the processes and materials employed in P&A in order to address the need for simplified P&A methodology, improved well sealing quality, or both. In addition, the foregoing problems make it clear that there is a need for the industry to provide methods and/or materials suitable for sealing both conventional or fractured (shale gas) wells.

Further in addition to the foregoing, it would be highly advantageous to provide methods and/or materials suitable for sealing either conventional or fractured wells, wherein the sealed wells are capable of preventing a flow of water from penetrating the sealed well, for example via fracture tips, thereby enabling the sealed well to by used as a water reservoir. In order to support a hydrostatic head without significant penetration of water within a subterranean formation, the P&A methods and materials employed must significantly reduce formation permeability as well as sustain a high operating pressure.

### SUMMARY

Described herein are methods of treating a subterranean formation. In some embodiments, the methods comprise, consist essentially of, or consist of packing at least a portion of a subterranean formation with a packing composition to form a packed subterranean formation; and applying a sealing composition to the packed subterranean formation to form a treated subterranean formation, wherein the packing composition comprises, consists essentially of, or consists of one or more metal oxide particulates, and the sealing composition comprises, consists essentially of, or consists of one or more silicate salts and a reactive silane mixture. In some such embodiments, the sealing composition is sprayed, pumped, poured onto the packed subterranean formation; in other such embodiments, the sealing composition is injected into the packed subterranean formation.

Alternatively, the methods of treating a subterranean formation comprise, consist essentially of, or consists of mixing a packing composition with a sealing composition to form a reactive composition, and packing at least a portion of a subterranean formation with the reactive composition to form a treated subterranean formation.

Also described herein are reactive compositions disposed within a subterranean formation, such as a drilled or fractured subterranean formation. In embodiments, a reactive composition comprises, consists essentially of, or consists of a packing composition comprising one or more metal oxide particulates combined with a sealing composition comprising, consisting essentially of, or consisting of one or more silicate salts, one or more epoxysilanes, and one or more aminosilanes. In embodiments, the one or more metal oxide particulates comprises, consists essentially of, or consists of a silica, an alumina, or any combination thereof; in embodiments, the metal oxide particulate comprises, consists essentially of, or consists of a sand, such as a sand particulate having an average particle size corresponding to 10-500 mesh. In embodiments, the reactive composition further includes a cure catalyst selected from CaCl₂, CaO, an acid, or any combination of these.

In embodiments, the methods herein further include curing a treated subterranean formation to form a sealed subterranean formation. In embodiments, curing is allowing a curing period of time to pass. In embodiments, the curing period is between 1 minute and 5 days. In embodiments, the treated subterranean formation is undisturbed during the curing. In embodiments, after the curing period has passed, the treated subterranean formation is a sealed subterranean formation.

Accordingly, further described herein are sealed subterranean formations, which are formed by curing treated subterranean formations. The sealed subterranean formations prevent or substantially prevent one or more fluids present within the subterranean formation from migrating, or emanating from the subterranean formation to a point above the surface of the earth: that is, in embodiments, a sealed subterranean formation includes, or retains, one or more emanants therein. In one or more embodiments the one or more emanants include one or more native fluids, that is, subterranean water, petroleum liquids, and/or gases present within the subterranean formation, such as produced water, crude oil, hydrogen sulfide, and carbon dioxide. In one or more embodiments the one or more emanants include one or more extraneous fluids sourced from outside the subterranean formation and injected therein, such as injected water, extraneous produced water, industrially treated water, waste water, extraneous carbon dioxide, flue gas, hydrogen gas, and the like.

In embodiments where the sealed subterranean formation retains one or more extraneous fluids within a subterranean environment, the sealed subterranean formation is also a subterranean storage reservoir for the one or more extraneous fluids. Accordingly, described herein are subterranean fluid storage reservoirs comprising, consisting essentially of, or consisting of a sealed subterranean formation and one or more extraneous fluids retained therein. In embodiments, the fluids retained within a subterranean fluid storage reservoir include one or more native fluids and one or more extraneous fluids.

In some embodiments, a subterranean reservoir is partially sealed, wherein one or more partial seals prevents fluids from entering one or more selected portions of the reservoir, but does not prevent fluid entry into the reservoir altogether. In such embodiments, the partially sealed subterranean reservoir obtains a directed flow of fluids therein, such that injecting fluids into a partially sealed subterranean reservoir obtains a more efficient or controlled pathway for crude oil recovery and/or avoids loss of fluids into areas of the reservoir that resist recirculation of injected fluids and instead drain a portion of an injected fluid away from the reservoir where it cannot be recovered. Accordingly, a partially sealed subterranean reservoir is a controlled flow reservoir that reduces or even eliminates loss of circulation materials during injection and/or recovery of crude oil products.

In some embodiments, a partially sealed subterranean reservoir is formed drilling or fracturing to establish a well thereto, to extract a native fluid from the reservoir. In such embodiments, inadvertent fractures formed during drilling or fracturing are sealed using one of the methods set forth above, to avoid loss of fluids into areas of the reservoir that resist recirculation of injected fluids and instead drain a portion of an injected fluid away from the reservoir where it cannot be recovered. Industrially, in such applications, the reactive compositions obtain the function of Loss Control Materials (LCM) since they can be applied to a portion of a subterranean reservoir during drilling or fracturing thereof and cured in place to form a partially sealed subterranean reservoir that obtains a directed flow of fluids therein.

In some embodiments, an extraneous water source comprising, consisting essentially of, or consisting of water is added to the upper surface of a sealed subterranean formation or a subterranean fluid storage reservoir formed in accordance with the foregoing methods and compositions, wherein the extraneous water source contacts at least a portion of an upper surface of the sealed subterranean formation or subterranean fluid storage reservoir, further wherein the extraneous water source is retained or substantially retained above ground, that is, on the surface of the earth. As used herein, the “upper surface” of a sealed subterranean formation or a subterranean fluid storage reservoir is the area where the cured composition, formed using methods and compositions of first through third embodiments, forms an interface with the atmosphere. In embodiments, the retaining is substantially or completely without loss of the extraneous water source into the earth via the area surrounding the subterranean areas occupied by, or in contact with the sealed subterranean formation or subterranean fluid storage reservoir.

In embodiments where a sealed subterranean formation or a subterranean fluid storage reservoir contacts an extraneous water source located on the surface of the earth, and retains the extraneous water source in the location, the sealed subterranean formation or subterranean fluid storage reservoir is also a surface water reservoir, or is part of a surface water reservoir. Accordingly, described herein are surface water reservoirs comprising, consisting essentially of, or consisting of a sealed subterranean formation or a subterranean fluid storage reservoir, wherein at least a portion of the sealed subterranean formation or subterranean fluid storage reservoir contacts an extraneous water source located on the surface of the earth.

Accordingly, described herein are methods of forming a surface water reservoir, the methods comprising, consisting essentially of, or consisting of forming a sealed subterranean formation or a subterranean fluid storage reservoir in accordance with the foregoing methods and compositions; and adding an extraneous water source to the surface of the earth located on top of the sealed subterranean formation or subterranean fluid storage reservoir, such that at least a portion of the sealed subterranean formation or subterranean fluid storage reservoir contacts an extraneous water source.

In some embodiments, the extraneous water source applies a hydrostatic pressure to at least one point on the upper surface of the sealed subterranean formation or subterranean fluid storage reservoir, substantially or completely without loss of the extraneous water source into the earth via the subterranean areas occupied by or in contact with the sealed subterranean formation or subterranean fluid storage reservoir. In embodiments, the extraneous water source applies a hydrostatic pressure of 0.1 psi to 2000 psi to at least a portion of the upper surface of a sealed subterranean formation or subterranean fluid storage reservoir, substantially or completely without loss of the water source into the earth via the subterranean areas occupied by or in contact with the sealed subterranean formation or subterranean fluid storage reservoir.

### BRIEF DESCRIPTION OF THE DRAWINGS

The accompanying drawings, which are incorporated in and constitute a part of this application, illustrate several aspects of the invention and together with a description of the embodiments serve to explain the principles of the invention. The drawings include photographs in grayscale to provide sufficient detail to illustrate the claimed invention. A brief description of the drawings is as follows:

FIG. 1 is a photograph of a sandpack formed using a method of the invention in accordance with a first formulation described herein.

FIG. 2 is a photograph of a sandpack formed using a method of the invention in accordance with a second formulation described herein.

FIG. 3 is a photograph of a sandpack formed using a method of the invention in accordance with a third formulation described herein.

FIG. 4 is a photograph of a sandpack formed using a method of the invention in accordance with a fourth formulation described herein.

FIG. 5 is a photograph of a sandpack formed using a method of the invention in accordance with a fifth formulation described herein.

### DETAILED DESCRIPTION

The aspects of the present invention described below are not intended to be exhaustive or to limit the invention to the precise forms disclosed in the following detailed description. Rather a purpose of the aspects chosen and described is by way of illustration or example, so that the appreciation and understanding by others skilled in the art of the general principles and practices of the present invention can be facilitated.

Unless otherwise indicated, all parts and percentages recited herein are by weight, and all molecular weights are weight average molecular weights.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

As used herein, the terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of’ and “consisting essentially of,” the embodiments or elements presented herein, whether explicitly set forth or not.

As used herein, the term “optional” or “optionally” means that the subsequently described event or circumstance may but need not occur, and that the description includes instances where the event or circumstance occurs and instances in which it does not.

As used herein, the term “about” modifying, for example, the quantity of an ingredient in a composition, concentration, volume, process temperature, process time, yield, flow rate, pressure, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities. Further, where “about” is employed to describe a range of values, for example “about 1 to 5” the recitation means “1 to 5” and “about 1 to about 5” and “1 to about 5” and “about 1 to 5” unless specifically limited by context.

As used herein, the term “significant” or “significantly” means at least half, or 50% by some measure as defined or as determined by context. For example, a solution that contains a “significant amount” of a component contains 50% or more of that component by weight, or by volume, or by some other measure as appropriate and in context. A solution wherein a component has been significantly removed has had at least 50% of the original amount of that component removed by weight, or by volume, or by some other measure as appropriate and in context.

As used herein, the word “substantially” modifying, for example, the type or quantity of an ingredient in a composition, a property, a measurable quantity, a method, a position, a value, or a range, employed in describing the embodiments of the disclosure, refers to a variation that does not affect the overall recited composition, property, quantity, method, position, value, or range thereof in a manner that negates an intended composition, property, quantity, method, position, value, or range. Examples of intended properties include, solely by way of nonlimiting examples thereof, flexibility, partition coefficient, rate, solubility, temperature, and the like; intended values include thickness, yield, weight, concentration, and the like. The effect on methods that are modified by “substantially” include the effects caused by variations in type or amount of materials used in a process, variability in machine settings, the effects of ambient conditions on a process, and the like wherein the manner or degree of the effect does not negate one or more intended properties or results; and like proximate considerations. Where modified by the term “substantially” the claims appended hereto include equivalents to these types and amounts of materials.

### First Embodiments

Disclosed herein are first embodiments that are methods of treating subterranean formations. The methods of first embodiments comprise, consist essentially of, or consist of packing at least a portion of a subterranean formation with a packing composition to form a packed subterranean formation; and applying a sealing composition to the packed subterranean formation to form a treated subterranean formation. Alternatively in first embodiments, the methods comprise, consist essentially of, or consist of mixing a packing composition with a sealing composition to form a reactive composition, and applying the reactive composition to at least a portion of a subterranean formation to form a treated subterranean formation. In any one or more first embodiments herein, the subterranean formation is a drilled or fractured formation.

In any one or more first embodiments herein, the packing composition comprises, consists essentially of, or consists of one or more metal oxide particulates. In any one or more first embodiments herein, the one or more metal oxide particulates comprises, consists essentially of, or consists of a silica, an alumina, or any combination thereof. In any one or more first embodiments herein, the one or more metal oxide particulates comprises, consists essentially of, or consists of a sand.

In any one or more first embodiments herein, the metal oxide particulate has a particle size of about 10 mesh to about 500 mesh as determined by screen classification, for example 10 mesh to 500 mesh, or 20 mesh to 500 mesh, or 30 mesh to 500 mesh, or 40 mesh to 500 mesh, or 50 mesh to 500 mesh, or 60 mesh to 500 mesh, or 70 mesh to 500 mesh, or 80 mesh to 500 mesh, or 90 mesh to 500 mesh, or 100 mesh to 500 mesh, or 120 mesh to 500 mesh, or 140 mesh to 500 mesh, or 160 mesh to 500 mesh, or 180 mesh to 500 mesh, or 200 mesh to 500 mesh, or 220 mesh to 500 mesh, or 240 mesh to 500 mesh, or 260 mesh to 500 mesh, or 280 mesh to 500 mesh, or 300 mesh to 500 mesh, or 320 mesh to 500 mesh, or 340 mesh to 500 mesh, or 360 mesh to 500 mesh, or 380 mesh to 500 mesh, or 400 mesh to 500 mesh, or 420 mesh to 500 mesh, or 440 mesh to 500 mesh, or 460 mesh to 500 mesh, or 480 mesh to 500 mesh, or 10 mesh to 480 mesh, or 10 mesh to 460 mesh, or 10 mesh to 440 mesh, or 10 mesh to 420 mesh, or 10 mesh to 400 mesh, or 10 mesh to 380 mesh, or 10 mesh to 360 mesh, or 10 mesh to 340 mesh, or 10 mesh to 320 mesh, or 10 mesh to 300 mesh, or 10 mesh to 280 mesh, or 10 mesh to 260 mesh, or 10 mesh to 240 mesh, or 10 mesh to 220 mesh, or 10 mesh to 200 mesh, or 10 mesh to 180 mesh, or 10 mesh to 160 mesh, or 10 mesh to 140 mesh, or 10 mesh to 120 mesh, or 10 mesh to 100 mesh, or 10 mesh to 90 mesh, or 10 mesh to 80 mesh, or 10 mesh to 70 mesh, or 10 mesh to 60 mesh, or 10 mesh to 50 mesh, or 10 mesh to 40 mesh, or 10 mesh to 30 mesh, or 10 mesh to 20 mesh, or 20 mesh to 30 mesh, or 30 mesh to 40 mesh, or 40 mesh to 50 mesh, or 50 mesh to 60 mesh, or 60 mesh to 70 mesh, or 70 mesh to 80 mesh, or 80 mesh to 90 mesh, or 90 mesh to 100 mesh, or 100 mesh to 120 mesh, or 120 mesh to 140 mesh, or 140 mesh to 160 mesh, or 160 mesh to 180 mesh, or 180 mesh to 200 mesh, or 200 mesh to 220 mesh, or 220 mesh to 240 mesh, or 240 mesh to 260 mesh, or 260 mesh to 280 mesh, or 280 mesh to 300 mesh, or 300 mesh to 3420 mesh, or 320 mesh to 340 mesh, or 340 mesh to 360 mesh, or 360 mesh to 380 mesh, or 380 mesh to 400 mesh, or 400 mesh to 420 mesh, or 420 mesh to 440 mesh, or 440 mesh to 460 mesh, or 460 mesh to 480 mesh as determined by screen classification.

In any one or more first embodiments herein, the metal oxide particulate comprises, consists essentially of, or consists of spherical particles or substantially spherical particles. In any one or more first embodiments herein, the metal oxide particulate comprises, consists essentially of, or consists of aspherical particles or substantially aspherical particles.

In any one or more first embodiments herein, the packing composition further comprises one or more additional inorganic particulates. In any one or more first embodiments herein, the one or more additional particulates are insoluble in water. In any one or more first embodiments herein, the one or more additional particulates are selected from gilsonites, lignites, calcium carbonate, barium sulfate, cement particles, nanofillers, carbon black/fibers/nanotubes, magnesium hydroxide, aluminum hydroxide, and fly ash or any combination thereof.

In any one or more first embodiments herein, the sealing composition comprises, consists essentially of, or consists of one or more silicate salts and a reactive silane mixture. In any one or more first embodiments herein, the one or more silicate salts comprises sodium silicate or another silicate salt, such as lithium silicate, ammonium silicate, and the like. In any one or more first embodiments herein, the silicate salt is water soluble. In any one or more first embodiments herein, the silicate salt is admixed with the reactive silane mixture to form the sealing composition. In embodiments, the silicate salt is provided in an aqueous solution; in other embodiments the silicate salt is provided in substantially dry form, that is, as a solid particulate. In any one or more first embodiments herein, the silicate salt is admixed with the reactive silane mixture to form the sealing composition. In any one or more first embodiments herein, the proportion by weight of the one or more silicate salts to the reactive silane mixture is about 5:1 to about 1:5, for example 5:1 to 1:5, or 5:1 to 1:4, or 5:1 to 1:3, or 5:1 to 1:2, or 5:1 to 1:1, or 5:1 to 2:1, or 5:1 to 3:1, or 5:1 to 4:1, or 4:1 to 1:5, or 3:1 to 1:5, or 2:1 to 1:5, or 1:1 to 1:5, or 1:2 to 1:5, or 1:3 to 1:5, or 1:4 to 1:5, or about 5:1, or about 3:1, or about 2:1, or about 1:1, or about 1:2, or about 1:3, or about 1:4, or about 1:5.

In any one or more first embodiments herein, the reactive silane mixture comprises, consists essentially of, or consists of one or more epoxysilanes and one or more aminosilanes. In any one or more first embodiments herein, the one or more epoxysilanes are selected from compounds having structure I:

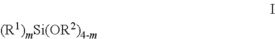

wherein m is 1 or 2, each R¹ is independently an epoxy-functional organic moiety, and each R² is independently H, CH₃, or CH₂CH₃. In any one or more first embodiments herein, m is 1. In any one or more first embodiments herein, each of the one or more epoxy-functional organic moieties R¹ includes one, two, three, four, or five epoxy groups. In any one or more first embodiments herein, each R¹ includes one or more 2,3-epoxypropoxy (glycidyl) groups. In any one or more first embodiments herein, each R² is CH₃. In any one or more first embodiments herein, each R² is CH₂—CH₃. In any one or more first embodiments herein, the one or more epoxysilanes comprises one or more 3-(2,3-epoxypropoxy)propyltrialkoxysilanes, which are also referred to herein as 3-glycidoxypropyltrialkoxysilanes.

In any one or more first embodiments herein, the one or more aminosilanes are selected from compounds having structure II:

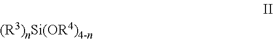

wherein n is 1 or 2, each R³ is independently an amine-functional organic moiety, and each R⁴ is independently selected from H, CH₃, and CH₂CH₃. In any one or more first embodiments herein, n is 1. In any one or more first embodiments herein, each of the one or more amine-functional organic moieties R³ includes one, two, three, four, or five amine groups. In any one or more first embodiments herein, each R³ is 3-aminopropyl. In any one or more first embodiments herein, one or more amine-functional organic moieties comprise one or more primary amine groups. In any one or more first embodiments herein, each of the one or more amine-functional organic moieties comprises one or more primary amine groups. In any one or more first embodiments herein, all of the amine groups of R³ are primary amine groups. In any one or more first embodiments herein, each R⁴ is CH₃. In any one or more first embodiments herein, each R⁴ is CH₂—CH₃. In any one or more first embodiments herein, the one or more aminosilanes comprises one or more 3-(2-aminoethylamino)propyltrialkoxysilanes, one or more N-(2-aminoethyl)-3-aminopropyltrialkoxysilanes, and/or one or more (3-aminopropyl)trialkoxysilanes.

As noted above, the reactive silane mixture of first embodiments herein comprises, consists essentially of, or consists of the one or more epoxysilanes and the one or more aminosilanes. Further as noted above, in any one or more first embodiments herein, the proportion by weight of the one or more silicate salts to the reactive silane mixture is about 5:1 to about 1:5. Accordingly, the proportion by weight of the one or more silicate salts to the combined weight of the one or more epoxysilanes and the one or more aminosilanes combined in the sealing composition of methods of first embodiments is about 5:1 to about 1:5, that is, 5:1 to 1:5, or 5:1 to 1:4, or 5:1 to 1:3, or 5:1 to 1:2, or 5:1 to 1:1, or 5:1 to 2:1, or 5:1 to 3:1, or 5:1 to 4:1, or 4:1 to 1:5, or 3:1 to 1:5, or 2:1 to 1:5, or 1:1 to 1:5, or 1:2 to 1:5, or 1:3 to 1:5, or 1:4 to 1:5, or about 5:1, or about 3:1, or about 2:1, or about 1:1, or about 1:2, or about 1:3, or about 1:4, or about 1:5.

Further, in any one or more first embodiments herein, the proportion by weight of the one or more epoxysilanes to the one or more aminosilanes in the reactive silane mixture is about 5:1 to about 1:5, for example 5:1 to 1:5, or 5:1 to 1:4, or 5:1 to 1:3, or 5:1 to 1:2, or 5:1 to 1:1, or 5:1 to 2:1, or 5:1 to 3:1, or 5:1 to 4:1, or 4:1 to 1:5, or 3:1 to 1:5, or 2:1 to 1:5, or 1:1 to 1:5, or 1:2 to 1:5, or 1:3 to 1:5, or 1:4 to 1:5, or about 5:1, or about 3:1, or about 2:1, or about 1:1, or about 1:2, or about 1:3, or about 1:4, or about 1:5. Further, in any one or more first embodiments herein, the proportion of the one or more epoxysilanes to the one or more aminosilanes in the reactive silane mixture is selected to provide a molar ratio of epoxy groups to amine groups of about 2:1 to about 1:2, for example about 2:1, about 1:1, or about 1:2. In any one or more first embodiments herein, the reactive silane mixture is selected to provide a molar ratio of epoxy groups to amine groups of 1:1 or about 1:1.

In any one or more first embodiments herein, the sealing composition further comprises one or more polymers. In any one or more first embodiments herein, the one or more polymers comprise, consist essentially of, or consist of one or more synthetic polymers. In any one or more first embodiments herein, the one or more polymers comprise, consist essentially of, or consist of one or more biobased polymers. In any one or more first embodiments herein, the one or more polymers comprise, consist essentially of, or consist of a combination of one or more synthetic polymers and one or more biobased polymers. In any one or more first embodiments herein, the one or more polymers comprise, consist essentially of, or consist of one or more water soluble or water dispersible polymers. In any one or more first embodiments herein, the one or more polymers comprise, consist essentially of, or consist of a crosslinked polymer or an interpenetrating network (IPN) of two or more polymers that differ chemically or by molecular weight, optionally wherein one or more of the IPN polymers is crosslinked. In any one or more first embodiments herein, the one or more polymers comprise, consist essentially of, or consist of one or more polyacrylamides, one or more partially hydrolyzed polyacrylamides, one or more polymethylolacrylamides, one or more polyalkylene glycols, one or more polyvinyl alcohols, one or more polyvinyl acetates, one or more guar gums, one or more locust bean gums, one or more xanthan gums, one or more celluloses, one or more hemicelluloses, one or more starches, one or more lignins, one or more hydroxymethylcelluloses, one or more hydroxyethylcelluloses, one or more derivatives of any one or more thereof, one or more copolymers of any one or more thereof, one or more crosslinked versions of any one or more thereof, or any mixture or combination of two or more thereof, wherein such mixtures or combinations can include IPNs.

In any one or more first embodiments herein, the one or more polymers are present in the sealing composition at a total of about 100 ppm to about 10,000 ppm by weight of the sealing composition, for example 100 ppm to 10,000 ppm, or 500 ppm to 9,000 ppm, or 100 ppm to 8,000 ppm, or 100 ppm to 7,000 ppm, or 100 ppm to 6,000 ppm, or 100 ppm to 5,000 ppm, or 100 ppm to 4,000 ppm, or 100 ppm to 3,000 ppm, or 100 ppm to 2,000 ppm, or 100 ppm to 1,000 ppm, or 100 ppm to 500 ppm, or 500 ppm to 10,000 ppm, or 1,000 ppm to 10,000 ppm, or 2,000 ppm to 10,000 ppm, or 3,000 ppm to 10,000 ppm, or 4,000 ppm to 10,000 ppm, or 5,000 ppm to 10,000 ppm, or 6,000 ppm to 10,000 ppm, or 7,000 ppm to 10,000 ppm, or 8,000 ppm to 10,000 ppm, or 9,000 ppm to 10,000 ppm, or 500 ppm to 600 ppm, or 600 ppm to 700 ppm, or 700 ppm to 800 ppm, or 800 ppm to 900 ppm, or 900 ppm to 1000 ppm, or 1000 ppm to 2000 ppm, or 2000 ppm to 3000 ppm, or 3000 ppm to 4000 ppm, or 4000 ppm to 5000 ppm, or 5000 ppm to 6000 ppm, or 6000 ppm to 7000 ppm, or 7000 ppm to 8000 ppm, or 8000 ppm to 9000 ppm, or 9000 ppm to 10,000 ppm by weight of the sealing composition.

In any one or more first embodiments herein, the sealing composition further comprises a solvent. In any one or more first embodiments herein, the solvent comprises, consists essentially of, or consists of water, a water-miscible or partly water-miscible liquid, a petroleum-based liquid, or any combination thereof, wherein “liquid” in this context means a compound or mixture thereof that is a liquid a temperature between −20° C. and 100° C. at 1 atmosphere. In any one or more first embodiments herein, the solvent is present in the sealing composition at about 1% to about 99% by weight of the sealing composition, for example 1% to 99%, or 1% to 98%, or 1% to 95%, or 1% to 90%, or 1% to 80%, or 1% to 70%, or 1% to 60%, or 0.% to 50%, or 1% to 40%, or 1% to 30%, or 1% to 20%, or 1% to 10%, or 0% to 5%, or 1% to 4%, or 1% to 3%, or 1% to 2%, or 1% to 5%, or 5% to 10%, or 10% to 15%, or 15% to 20%, or 20% to 25%, or 25% to 30%, or 30% to 40%, or 40% to 50%, or 50% to 60%, or 60% to 70%, or 70% to 80%, or 85% to 90%, or 90% to 95%, or 95% to 96%, or 96% to 97%, or 97% to 98%, or 98% to 99% by weight of the sealing composition. In any one or more first embodiments herein, where a sealing composition includes one or more solvents, the one or more solvents are not included in disclosed ranges, ratios, or specified amounts of packing composition components or sealing composition components unless such ranges, ratios, or specified amounts of such components include the solvent explicitly or by context.

In any one or more first embodiments herein, the solvent comprises, consists essentially of, or consists of water. In any one or more first embodiments herein, the solvent comprises, consists essentially of, or consists of one or more water miscible or partly water miscible liquids. In any one or more first embodiments herein, the one or more water miscible or partly water miscible liquids are selected from one or more glycols, one or more polyols, one or more carbonates, one or more C1-C10 alkanols, one or more C2-C8 ketones, one or more C1-C8 aldehydes, one or more C2-C8 esters, or any combination thereof. In any one or more first embodiments herein, the solvent comprises, consists essentially of, or consists of a petroleum-based liquid, that is, a hydrocarbon liquid such as hexane, heptane, cetane, toluene, xylene; or a hydrocarbon liquid mixture selected from diesel fuels, gasolines, jet fuels, kerosene, petroleum middle distillates, heavy aromatic naphtha, or any combination thereof.

In any one or more first embodiments herein, a curing agent is added to a sealing composition, or to a reactive composition, or to a treated subterranean formation. In any one or more first embodiments herein, the curing agent comprises, consists essentially of, or consists of CaCl₂, CaO, an acid, or any combination thereof. In any one or more first embodiments herein, the acid comprises, consists essentially of, or consists of sulfuric acid, hydrochloric acid, sulfamic acid, nitric acid, formic acid, acetic acid, toluenesulfonic acid, citric acid, or any combination thereof. In any one or more first embodiments herein, one or more curing agents are present in a sealing composition, or a reactive composition, or a treated subterranean formation in an amount of about 0.1 wt % to about 10 wt % based on the weight of sealing composition actives, where “actives” are all non-solvent components of the sealing composition. For example, in any one or more first embodiments herein, one or more curing agents are present in a sealing composition, or a reactive composition, or a treated subterranean formation in an amount of 0.1 wt % to 1 wt %, or 1 wt % to 10 wt %, or 2 wt % to 10 wt %, or 3 wt % to 10 wt %, or 4 wt % to 10 wt %, or 5 wt % to 10 wt %, or 6 wt % to 10 wt %, or 7 wt % to 10 wt %, or 8 wt % to 10 wt %, or 9 wt % to 10 wt %, or 1 wt % to 9 wt %, or 1 wt % to 8 wt %, or 1 wt % to 7 wt %, or 1 wt % to 6 wt %, or 1 wt % to 5 wt %, or 1 wt % to 4 wt %, or 1 wt % to 3 wt %, or 1 wt % to 2 wt %, or 2 wt % to 3 wt %, or 3 wt % to 4 wt %, or 4 wt % to 5 wt %, or 5 wt % to 6 wt %, or 6 wt % to 7 wt %, or 7 wt % to 8 wt %, or 8 wt % to 9 wt % of the total weight of the sealing composition actives present in a sealing composition, reactive composition, or treated subterranean formation.

In some first embodiments herein, a curing agent is mixed with a sealing composition prior to contacting the sealing composition with the packed subterranean formation. In other first embodiments, a curing agent is mixed with a sealing composition prior to mixing the sealing composition with a packing composition to form a reactive composition. In still other first embodiments, a curing agent is mixed in any order with a sealing composition and a packing composition to form a reactive composition. In still other first embodiments, a curing agent is added to a treated subterranean formation.

Accordingly, in some first embodiments herein, a method of sealing a subterranean formation comprises, consists essentially of, or consists of packing at least a portion of the subterranean formation with a packing composition to form a packed subterranean formation; applying a sealing composition to the packed subterranean formation to form a first treated subterranean formation, the sealing composition excluding a curing agent; and applying a curing agent to the first treated subterranean formation to form a second treated subterranean formation.

Alternatively, in other first embodiments herein, a method of sealing a subterranean formation comprises, consists essentially of, or consists of mixing a packing composition and a sealing composition to form a reactive composition, the reactive composition excluding a curing agent; packing at least a portion of the subterranean formation with the reactive composition to form a first treated subterranean formation; and applying a curing agent to the first treated subterranean formation to form a second treated subterranean formation. In related first embodiments herein, a method of sealing a subterranean formation comprises, consists essentially of, or consists of mixing a packing composition with a sealing composition to form a first reactive composition, adding a curing agent to the first reactive composition to form a second reactive composition; and packing at least a portion of the subterranean formation with the second reactive composition to form a second treated subterranean formation. In other related first embodiments herein, a method of sealing a subterranean formation comprises, consists essentially of, or consists of mixing a packing composition with a sealing composition to form a first reactive composition; packing at least a portion of the subterranean formation with the first reactive composition to form a first treated subterranean formation; and adding a curing agent to the first treated subterranean formation to form a second treated subterranean formation.

In any one or more of the foregoing methods of first embodiments, the second treated subterranean formation obtains a faster rate of cure than a first treated subterranean formation: stated differently, a treated subterranean formation comprising a curing agent obtains a cured subterranean formation faster than a treated subterranean formation excluding a curing agent. In embodiments, the curing agent is mixed with a solvent prior to adding the curing agent to the first treated subterranean formation or mixing the curing agent with the first reactive composition; in such embodiments, the solvent comprises, consists essentially of, or consists of water and/or any one or more of the water miscible or partly water miscible liquids disclosed above.

The packing compositions and sealing compositions described herein are easily formed by admixing the components thereof in the amounts or ratios indicated above, and further as specifically selected by an operator to provide optimal components and amounts thereof to meet the needs of a particular drilled or fractured formation or portion thereof that is in need of sealing. Further, the reactive compositions described herein are easily formed by admixing the components thereof in the amounts or ratios indicated above, often using mixing equipment such as agitator blenders and frac blenders to obtain satisfactory distribution of the sealing composition around the particles of the packing composition.

In any one or more first embodiments herein, a packing composition or a reactive composition is suitably applied to a drilled or fractured formation by pumping or pouring the packing composition or the reactive composition into or onto a formation.

In any one or more first embodiments herein, a packed subterranean formation is a drilled or fractured formation wherein at least a portion of the formation is packed with a packing composition in an amount corresponding to about 0.3 to about 2.00 grams of packing composition per milliliter of formation volume (that is, g/mL), for example 0.30 g/mL to 2.00 g/mL, or 0.50 g/mL to 2.00 g/mL, or 0.70 g/mL to 2.00 g/mL, or 1.00 g/mL to 2.00 g/mL, or 1.20 g/mL to 2.00 g/mL, or 1.40 g/mL to 2.00 g/mL, or 1.60 g/mL to 2.00 g/mL, or 1.80 g/mL to 2.00 g/mL, or 0.30 g/mL to 1.80 g/mL, or 0.30 g/mL to 1.60 g/mL, or 0.30 g/mL to 1.40 g/mL, or 0.30 g/mL to 1.20 g/mL, or 0.30 g/mL to 1.00 g/mL, or 0.30 g/mL to 0.80 g/mL, or 0.30 g/mL to 0.60 g/mL, or 0.30 g/mL to 0.40 g/mL, or 0.30 g/mL to 0.50 g/mL, or 0.50 g/mL to 0.70 g/mL, or 0.70 g/mL to 1.00 g/mL, or 1.00 g/mL to 1.20 g/mL, or 1.20 g/mL to 1.40 g/mL, or 1.40 g/mL to 1.60 g/mL, or 1.60 g/mL to 1.80 g/mL, or 1.80 g/mL to 2.00 g/mL of the packing composition in the packed formation. In any one or more first embodiments herein, a treated subterranean formation is a drilled or fractured formation wherein at least a portion of the formation is packed with a reactive composition in an amount corresponding to about 0.3 to about 2.00 grams of reactive composition per milliliter of formation volume (that is, g/mL), for example 0.30 g/mL to 2.00 g/mL, or 0.50 g/mL to 2.00 g/mL, or 0.70 g/mL to 2.00 g/mL, or 1.00 g/mL to 2.00 g/mL, or 1.20 g/mL to 2.00 g/mL, or 1.40 g/mL to 2.00 g/mL, or 1.60 g/mL to 2.00 g/mL, or 1.80 g/mL to 2.00 g/mL, or 0.30 g/mL to 1.80 g/mL, or 0.30 g/mL to 1.60 g/mL, or 0.30 g/mL to 1.40 g/mL, or 0.30 g/mL to 1.20 g/mL, or 0.30 g/mL to 1.00 g/mL, or 0.30 g/mL to 0.80 g/mL, or 0.30 g/mL to 0.60 g/mL, or 0.30 g/mL to 0.40 g/mL, or 0.30 g/mL to 0.50 g/mL, or 0.50 g/mL to 0.70 g/mL, or 0.70 g/mL to 1.00 g/mL, or 1.00 g/mL to 1.20 g/mL, or 1.20 g/mL to 1.40 g/mL, or 1.40 g/mL to 1.60 g/mL, or 1.60 g/mL to 1.80 g/mL, or 1.80 g/mL to 2.00 g/mL of the reactive composition in a treated formation.

In any one or more first embodiments herein, applying a sealing composition to a packed subterranean formation to form a treated subterranean formation comprises, consists essentially of, or consists of spraying, pumping, or pouring a sealing composition onto a packed subterranean formation using conventional equipment for applying a liquid composition to a subterranean formation or to a sandpack. In any one or more first embodiments herein, applying the sealing composition to the packed subterranean formation comprises, consists essentially of, or consists of applying a pressurized flow of the sealing composition to the packed subterranean formation. In any one or more first embodiments herein, the applying is accomplished by injecting a sealing composition into the packing composition, that is, applying a pressurized flow of a sealing composition to a portion of the packed subterranean formation at a location beneath the surface of the pack. In any one or more first embodiments herein, the applying is contacting all of the pack, or substantially all of the pack with the sealing composition.

In any one or more first embodiments herein, the proportion by weight of the packing composition disposed within the packed subterranean formation, to the sealing composition applied thereto is about 2:1 to about 100:1, for example 2:1 to 90:1, or 2:1 to 80:1, or 2:1 to 70:1, or 2:1 to 60:1, or 2:1 to 50:1, or 2:1 to 40:1, or 2:1 to 30:1, or 2:1 to 20:1, or 2:1 to 10:1, or 2:1 to 8:1, or 2:1 to 6:1, or 2:1 to 4:1, or 4:1 to 100:1, or 6:1 to 100:1, or 8:1 to 100:1, or 10:1 to 100:1, or 20:1 to 100:1, or 30:1 to 100:1, or 40:1 to 100:1, or 50:1 to 100:1, or 60:1 to 100:1, or 70:1 to 100:1, or 80:1 to 100:1, or 90:1 to 100:1, or 2:1 to 10:1, or 10:1 to 20:1, or 20:1 to 30:1, or 30:1 to 40:1, or 40:1 to 50:1, or 50:1 to 60:1, ot 60:1 to 70:1, or 70:1 to 80:1, or 80:1 to 90:1, or about 90:1, or about 80:1, or about 70:1, or about 60:1, or about 50:1, or about 40:1, or about 30:1, or about 20:1, or about 10:1, or about 9:1, or about 8:1, or about 7:1, or about 6:1, or about 5:1, or about 4:1, or about 3:1, or about 2:1 by weight. In any one or more first embodiments herein, the proportion by weight of the metal oxide particulate to the sealing composition is about 2:1 to about 100:1, for example 2:1 to 90:1, or 2:1 to 80:1, or 2:1 to 70:1, or 2:1 to 60:1, or 2:1 to 50:1, or 2:1 to 40:1, or 2:1 to 30:1, or 2:1 to 20:1, or 2:1 to 10:1, or 2:1 to 8:1, or 2:1 to 6:1, or 2:1 to 4:1, or 4:1 to 100:1, or 6:1 to 100:1, or 8:1 to 100:1, or 10:1 to 100:1, or 20:1 to 100:1, or 30:1 to 100:1, or 40:1 to 100:1, or 50:1 to 100:1, or 60:1 to 100:1, or 70:1 to 100:1, or 80:1 to 100:1, or 90:1 to 100:1, or 2:1 to 10:1, or 10:1 to 20:1, or 20:1 to 30:1, or 30:1 to 40:1, or 40:1 to 50:1, or 50:1 to 60:1, to 60:1 to 70:1, or 70:1 to 80:1, or 80:1 to 90:1, or about 90:1, or about 80:1, or about 70:1, or about 60:1, or about 50:1, or about 40:1, or about 30:1, or about 20:1, or about 10:1, or about 9:1, or about 8:1, or about 7:1, or about 6:1, or about 5:1, or about 4:1, or about 3:1, or about 2:1.

Alternatively in any one or more first embodiments herein, applying a reactive composition to a subterranean formation to form a treated subterranean formation comprises, consists essentially of, or consists of admixing a sealing composition with a packing composition to form a reactive composition, optionally further including a cure catalyst; and spraying, pumping, or pouring the reactive composition onto or into the subterranean formation using conventional equipment for applying a high-solids slurry to a subterranean formation. In any one or more such first embodiments herein, the proportion by weight of the packing composition admixed with the sealing composition to obtain the reactive composition is about 2:1 to about 100:1, for example 2:1 to 90:1, or 2:1 to 80:1, or 2:1 to 70:1, or 2:1 to 60:1, or 2:1 to 50:1, or 2:1 to 40:1, or 2:1 to 30:1, or 2:1 to 20:1, or 2:1 to 10:1, or 2:1 to 8:1, or 2:1 to 6:1, or 2:1 to 4:1, or 4:1 to 100:1, or 6:1 to 100:1, or 8:1 to 100:1, or 10:1 to 100:1, or 20:1 to 100:1, or 30:1 to 100:1, or 40:1 to 100:1, or 50:1 to 100:1, or 60:1 to 100:1, or 70:1 to 100:1, or 80:1 to 100:1, or 90:1 to 100:1, or 2:1 to 10:1, or 10:1 to 20:1, or 20:1 to 30:1, or 30:1 to 40:1, or 40:1 to 50:1, or 50:1 to 60:1, to 60:1 to 70:1, or 70:1 to 80:1, or 80:1 to 90:1, or about 90:1, or about 80:1, or about 70:1, or about 60:1, or about 50:1, or about 40:1, or about 30:1, or about 20:1, or about 10:1, or about 9:1, or about 8:1, or about 7:1, or about 6:1, or about 5:1, or about 4:1, or about 3:1, or about 2:1. In any one or more such first embodiments herein, applying a reactive composition to a subterranean formation comprises, consists essentially of, or consists of applying a pressurized flow of the reactive composition to the subterranean formation. In any one or more such first embodiments herein, the applying is accomplished by injecting a reactive composition into the subterranean formation at a location beneath the surface of the earth to form a treated subterranean formation.

In any one or more first embodiments herein, the methods further include curing a treated subterranean formation to form a sealed subterranean formation. In any one or more first embodiments herein, curing is accomplished by allowing a curing period of time to pass after forming the treated subterranean formation, wherein the treated subterranean formation is undisturbed or substantially undisturbed during the curing period; and wherein the curing period is of a sufficient length that a treated subterranean formation becomes a sealed subterranean formation after the curing period passes. In any one or more first embodiments herein, “substantially undisturbed” means that the treated subterranean formation is not purposefully or physically manipulated or perturbed by the direct or indirect actions of any human. In any one or more first embodiments herein, the surface of the treated subterranean formation is covered, for example by one or more layers of sheet plastic or tarpaulins, during the curing period to shield the treated subterranean formation from inclement weather such as rain, debris moved by wind, and the like.

In any one or more first embodiments herein, the curing period is about 1 minute to about 5 days at a pressure of 1 atm and a temperature between 10° C. and 140° C., for example 1 minute to 5 days, or 30 minutes to 5 days, or 1 hour to 5 days, or 3 hours to 5 days, or 6 hours to 5 days, or 12 hours to 5 days, or 1 day to 5 days, or 2 days to 5 days, or 3 days to 5 days, or 4 days to 5 days, or 1 minute to 4 days, or 1 minute to 3 days, or 1 minute to 2 days, or 1 minute to 1 day, or 1 minute to 12 hours, or 1 minute to 6 hours, or 1 minute to 3 hours, or 1 minute to 1 hour, or 1 minute to 30 minutes at a pressure of 1 atm and a temperature between 10° C. and 140° C.

As noted above, in any one or more first embodiments herein, addition of a curing agent to a sealing composition provides a faster rate of cure (shorter curing period). We have also found that, unexpectedly, increasing the amount of curing agent in the sealing composition to as much as 10 wt % therein does not result in any observable difference between the properties of the cured compositions resulting therefrom, and a cured composition formed using a lower amount of the curing agent, such as 0.1 wt % or even less.

In any one or more first embodiments herein, at the end of the curing period, the treated subterranean formation is a sealed subterranean formation. The sealed subterranean formation includes a cured composition that is the in situ reaction product of a packing composition with a sealing composition (that is, a reactive composition). Without being limited by theory, we believe that the epoxysilane, aminosilane, and silicate salt components of the sealing compositions form covalent Si—O—Si bonds and ionic associations with the surfaces of the metal oxide particles of the packing compositions; and separately, the epoxy groups of the epoxysilane react with the amine groups of the aminosilane to form a cured network that includes the reaction product of the sealing composition with the packing composition. In accordance with the methods of first embodiments herein, the reaction product forms in situ within the subterranean formation, during the curing period. This is because the sealing composition is added to the packed subterranean formation, initiating the curing reaction by forming a reactive combination within a subterranean formation.

In any one or more first embodiments herein, prior to applying a packing composition or a reactive composition to a subterranean formation, the subterranean formation is pre-packed with one or more bulk materials to fill large spaces therein and provide a pre-packed area for application of the packing composition or reactive composition. Such bulk materials can include, but are not limited to, whole or comminuted mineral aggregates, nut shells, sand, seashells, Calcium carbonate, fibers, mica flakes, graphite, gilsonite, cedar bark, cotton hulls, and mixtures of these or similar materials.

### Second Embodiments

In accordance with the foregoing methods, disclosed herein are second embodiments which are treated subterranean formations. In any one or more second embodiments herein, a treated subterranean formation comprises, consists essentially of, or consists of a reactive composition disposed within a subterranean formation. In any one or more second embodiments herein, the subterranean formation is a drilled or fractured subterranean formation. In any one or more second embodiments herein, the comprises, consists essentially of, or consists of any one of the packing compositions of first embodiments, combined with any one of the sealing compositions of first embodiments, in a weight proportion about 2:1 to about 100:1 as disclosed in first embodiments; further wherein the reactive composition is uncured or only partially cured—that is, the curing period has not yet started, or has not yet passed.

In any one or more second embodiments herein, a treated subterranean formation is formed by any one or more methods of first embodiments. In some second embodiments, a treated subterranean formation is formed by applying a sealing composition to a packed subterranean formation, which forms a treated subterranean formation, the treated formation including a reactive composition. In other second embodiments, a treated subterranean formation is formed by applying a reactive composition to a subterranean formation. In either of these embodiments, the reactive composition is characterized as uncured, or partially cured.

Accordingly, in any one or more second embodiments herein, a reactive composition includes unreacted epoxy groups and/or unreacted amine groups and/or unreacted silane groups. In any one or more second embodiments herein, a reactive composition exists from the time of contact of a sealing composition with a packing composition, such as the packing composition present in a packed subterranean formation in accordance with the methods of first embodiments herein, until all or substantially all of the epoxy and/or amine and/or silane groups of the reactive composition are reacted, at which time the reactive composition is, becomes, or has become a cured composition. “Substantially all of the epoxy and/or amine and/or silane groups” means that while not all of the epoxy and/or amine and/or silane groups are reacted, a sufficient amount of these groups have reacted to provide properties associated with a sealed subterranean formation, as described in more detail below. Stated differently, a treated subterranean formation of second embodiments exists from the time a sealing composition is contacted with a packed subterranean formation, until all or substantially all of the epoxy and/or amine and/or silane groups of the reactive composition are reacted, at which time the treated subterranean formation is, becomes, or has become a sealed subterranean formation.

### Third Embodiments

Also disclosed herein are sealed subterranean formations formed in accordance with the methods and compositions of first or second embodiments herein. In any one or more third embodiments herein, a sealed subterranean formation comprises, consists essentially of, or consists of a cured composition of first embodiments disposed within a subterranean formation, such as drilled or fractured subterranean formation. In any one or more third embodiments herein, a sealed subterranean formation is formed using any one or more of the compositions and methods of first and second embodiments herein, wherein the methods include curing a treated subterranean formation to form a sealed subterranean formation. In any one or more third embodiments herein, a sealed subterranean formation includes a cured composition that is the in situ reaction product of a packing composition with a sealing composition (that is, a reactive composition) in or on a subterranean formation. In any one or more third embodiments herein, a sealed subterranean formation comprises, consists essentially of, or consists of a treated subterranean formation that is cured, that is, after allowing a curing period of time to pass after forming a treated subterranean formation. In any one or more third embodiments herein, the cured compositions comprise, consist essentially of, or consist of the in situ reaction product of a reactive composition of second embodiments herein.

Accordingly, in any one or more third embodiments herein, a sealed subterranean formation is formed by packing at least a portion of a subterranean formation with a packing composition to form a packed subterranean formation; applying a sealing composition to the packed subterranean formation to form a treated subterranean formation; and curing the treated subterranean formation to form a sealed subterranean formation. Additionally, in any one or more third embodiments herein, a sealed subterranean formation is formed by packing at least a portion of a subterranean formation with a reactive composition to form a treated subterranean formation; and curing the treated subterranean formation to form a sealed subterranean formation. The sealed subterranean formations prevent or substantially prevent one or more fluids present within the subterranean formation from migrating, or emanating from the subterranean formation to a point above the surface of the earth. The partially sealed subterranean formations obtain a controlled flow of one or more fluids within the subterranean formation.

In any one or more third embodiments herein, the sealed subterranean formations prevent or substantially prevent one or more fluids residing within the subterranean formation from migrating, or emanating above the surface of the earth. Accordingly, as used herein, an “emanant” refers to a compound or a group of compounds present within a subterranean formation and desirably prevented or substantially prevented from emanating to a point above the surface of the earth. By “substantially prevented” in this context, it is meant that the amount of one or more emanants emanating from a treated subterranean formation meets or exceeds one or more environmental, safety, and/or regulatory standards for the emanation of the one or more emanants. In some embodiments herein, an emanant is desirably prevented or substantially prevented from emanating to a point above the surface of the earth due to noxious odor, toxicity, or corrosivity thereof; tendency thereof to foul one or more surfaces; and/or the need to prevent fluid loss (that is, the desire to prevent depletion of materials from the subterranean environment).

As used herein, “substantially prevented from emanating” means that the amount of one or more emanants emanating from a sealed subterranean formation meets or exceeds one or more environmental, safety, and/or regulatory standards for the emanation of the one or more emanants. In some embodiments herein an emanant comprises one or more of the following properties: noxious odor, toxicity, corrosivity, flammability, and tendency to foul (precipitate on and adhere to) one or more surfaces. In one or more embodiments herein, the one or more emanants include one or more native fluids, which include subterranean water (connate), petroleum liquids, and/or gases present within the subterranean formation. Native subterranean water, or connate, present within a subterranean formation can include liquid hydrocarbon compounds and/or dissolved gases such as hydrogen sulfide and carbon dioxide, which are desirably prevented from emanating to a point above the surface of the earth.

Additionally, it is generally desirable to prevent depletion of some materials or compounds from the subterranean environment, such as connate, which can move along any of the subterranean paths created by the drilling or the fracturing to gain egress from the subterranean environment and emanate above the surface of the earth. Connate is also suitably characterized as a fluid emanant and is often the principal factor in fluid loss from an untreated or unsealed drilled or fractured petroleum well. Accordingly, in any one or more third embodiments herein, a sealed subterranean formation prevents or substantially prevents connate present in and proximal to the sealed subterranean formation from emanating above the surface of the earth.

In any one or more third embodiments herein, a sealed subterranean formation prevents or substantially prevents one or more emanants within the subterranean formation from emanating above the surface of the earth for a period of about 1 year to about 1000 years, for example 1 year to 5 years, or 5 years to 10 years, or 10 years to 20 years, or 20 years to 40 years, or 40 years to 100 years, or 100 years to 200 years, or 200 years to 300 years, or 300 years to 500 years, or 500 years to 1000 years.

In any one or more third embodiments herein, the upper surface of a sealed subterranean formation is characterized as having a continuously sealed appearance when viewed by the unaided human eye. In any one or more third embodiments herein, a cured composition present within sealed subterranean formation appears to have a continuously sealed upper surface, when viewed at a magnification between 2× and 1000×. In any one or more third embodiments herein, a cured composition present within sealed subterranean formation is resistant or impervious to direct manual damage inflicted using narrow-edged tools such as spatulae, knives, and the like.

### Fourth Embodiments

Also described herein are sealed subterranean formations in accordance with any one or more third embodiments herein, and further including one or more extraneous fluids retained within the sealed subterranean formation. Accordingly, disclosed in fourth embodiments herein are subterranean storage reservoirs comprising, consisting essentially of, or consisting of a sealed subterranean formation in accordance with any one or more third embodiments herein, and one or more extraneous fluids disposed within, and retained within the sealed subterranean formation and prevented, or substantially prevented from emanating above the surface of the earth. As used herein, the term “extraneous fluid” means a fluid that is present within a subterranean formation but sourced from outside the subterranean formation. In any one or more fourth embodiments herein, an extraneous fluid includes one or more emanants.

Accordingly, in fourth embodiments herein, one or more emanants present within a subterranean storage reservoir are sourced from outside the subterranean formation used to make the subterranean storage reservoir. Extraneous emanants include compounds that are, or are present in, an extraneous fluid, such as produced water, industrially treated water, waste water, extraneous carbon dioxide, flue gas, hydrogen gas, and the like. In any one or more fourth embodiments herein, the fluids retained within a subterranean fluid storage reservoir include one or more native fluids and one or more extraneous fluids. In any one or more fourth embodiments herein, the emanants retained within a subterranean fluid storage reservoir include one or more native emanants and one or more extraneous emanants.

Further in any one or more fourth embodiments herein, methods of forming a subterranean fluid storage reservoir comprise, consist essentially of, or consist of one or more Processes A, B, C, D, E, or F, wherein Process A is injecting an extraneous fluid into a subterranean formation to form a filled subterranean formation; packing at least a portion of the filled subterranean formation with a packing composition to form a packed, filled subterranean formation; applying a sealing composition to the packed, filled subterranean formation to form a treated filled subterranean formation, and curing the treated filled subterranean formation to form a subterranean fluid storage reservoir; Process B is packing at least a portion of a subterranean formation with a packing composition to form a packed subterranean formation; injecting an extraneous fluid into the packed subterranean formation to form a packed, filled subterranean formation; applying a sealing composition to the packed, filled subterranean formation to form a treated, filled subterranean formation, and curing the treated, filled subterranean formation to form a subterranean fluid storage reservoir; Process C is packing at least a portion of a subterranean formation with a packing composition to form a packed subterranean formation; applying a sealing composition to the packed subterranean formation to form a treated subterranean formation, injecting an extraneous fluid into the treated subterranean formation to form a treated, filled subterranean formation; and curing the treated, filled subterranean formation to form a subterranean fluid storage reservoir; Process D is packing at least a portion of a subterranean formation with a packing composition to form a packed subterranean formation; applying a sealing composition to the packed subterranean formation to form a treated subterranean formation, curing the treated subterranean formation to form a sealed subterranean formation, and injecting an extraneous fluid into the sealed subterranean formation to form a subterranean fluid storage reservoir; Process E is injecting an extraneous fluid into a subterranean formation to form a filled subterranean formation; packing at least a portion of the filled subterranean formation with a reactive composition to form a treated filled subterranean formation, and curing the treated filled subterranean formation to form a subterranean fluid storage reservoir; and Process F is packing at least a portion of a subterranean formation with a reactive composition to form a treated subterranean formation, curing the treated subterranean formation to form a sealed subterranean formation, and injecting an extraneous fluid into the sealed subterranean formation to form a subterranean fluid storage reservoir.

In any one or more of the foregoing Processes A-F, the injecting of an extraneous fluid is accomplished using any conventional process for injecting fluids into the earth, including pressurized injection of gases such as carbon dioxide and hydrogen. In some fourth embodiments herein, the well infrastructure previously employed to extract subterranean fluids from the well, such as pipes, casings, pumps, and the like, are suitably employed for injection of one or more extraneous fluids into the subterranean reservoir, followed by removing the infrastructure, and then treating and curing the subterranean reservoir in accordance with any one or more of first through third embodiments herein to obtain a subterranean fluid storage reservoir.

In some fourth embodiments herein, methods of forming a subterranean fluid storage reservoir comprise, consist essentially of, or consist of carrying out Steps 1, 2, and 3 with respect to a subterranean formation:
Step 1: pack a packing composition into the subterranean formation;
Step 2: apply a sealing composition to the packing composition;
Step 3: inject an extraneous fluid into the subterranean formation; wherein the Steps are carried out in the order 1, 2, 3; or the order 1, 3, 2; or the order 3, 1, 2.

### Fifth Embodiments

In addition to preventing or substantially preventing emanants from emanating above the surface of the earth, the sealed subterranean formations of third embodiments and the subterranean fluid storage reservoirs of fourth embodiments herein are characterized by their ability to prevent or substantially prevent downward migration of liquid water from above the surface of the earth. Accordingly, disclosed in fifth embodiments herein are surface water reservoirs comprising, consisting essentially of, or consisting of a sealed subterranean formation of any one of third embodiments herein, or a subterranean fluid storage reservoir in accordance with any one or more of fourth embodiments herein; and an extraneous water source contacting at least a portion of an upper surface of the sealed subterranean formation or subterranean fluid storage reservoir. As used herein, the “upper surface” of a sealed subterranean formation or a subterranean fluid storage reservoir is the area where the cured composition of the sealed subterranean formation or subterranean fluid storage reservoir, formed using any one of the methods and compositions of first through third embodiments herein, forms an interface with the atmosphere. In any one or more fifth embodiments herein, a surface water reservoir is formed by applying an extraneous water source comprising, consisting essentially of, or consisting of liquid water to the surface of the earth in a selected location on top of, or proximal to, the upper surface of a sealed subterranean formation or a subterranean fluid storage reservoir formed in accordance with the foregoing methods and compositions, wherein the extraneous water source contacts at least a portion of the upper surface of the sealed subterranean formation or subterranean fluid storage reservoir, and is retained thereon.

In a surface water reservoir of any one or more fifth embodiments herein, an extraneous water source contacting at least a portion of an upper surface of a sealed subterranean formation or subterranean fluid storage reservoir is substantially or completely retained thereon: that is, the extraneous water source does not migrate into the earth via the subterranean areas occupied by or in contact with the upper surface of the sealed subterranean formation or subterranean fluid storage reservoir. In any one or more fifth embodiments herein, an extraneous water source contacting at least a portion of the upper surface of a subterranean formation or subterranean fluid storage reservoir applies a hydrostatic pressure to at least one point on the contacted upper surface, further wherein the extraneous water source is substantially or completely retained thereon.

Terms such as “egress of liquid water”, “loss of the water source” and the like indicate the loss of an extraneous water source contacting at least one portion of the upper surface of a sealed subterranean formation or subterranean fluid storage reservoir via the subterranean areas occupied by, or in contact with, the sealed subterranean formation or subterranean fluid storage reservoir. In any one or more fifth embodiments herein, such loss by a surface water reservoir is less than about 200-400 mL/hour (3.33-6.66 mL/minute) under 1000 psi operating pressure.

Accordingly, disclosed in fifth embodiments herein are surface water reservoirs comprising, consisting essentially of, or consisting of a sealed subterranean formation of third embodiments, and an extraneous water source contacting at least a portion of an upper surface thereof and retained thereon. Also disclosed in any one more fifth embodiments herein are methods of forming a surface water reservoir comprising, consisting essentially of, or consisting of contacting an extraneous water source with a sealed subterranean formation of any of third embodiments herein, wherein the water source contacts at least a portion of an upper surface of the sealed subterranean formation and is retained thereon. Also disclosed in fifth embodiments herein are surface water reservoirs comprising, consisting essentially of, or consisting of a subterranean fluid storage reservoir of fourth embodiments herein, and an extraneous water source contacting at least a portion of an upper surface thereof and retained thereon. Also disclosed in any one more fifth embodiments herein are methods of forming a surface water reservoir comprising, consisting essentially of, or consisting of contacting an extraneous water source with a subterranean fluid storage reservoir of fourth embodiments herein, wherein the water source contacts at least a portion of an upper surface of the subterranean fluid storage reservoir and is retained thereon.

In any one or more surface water reservoirs of fifth embodiments herein, the extraneous water source contacts the entire upper surface of the of a sealed subterranean formation or a subterranean fluid storage reservoir. In any one or more surface water reservoirs of fifth embodiments herein, the extraneous water source comprises, consists essentially of, or consists of liquid water. In any one or more surface water reservoirs of fifth embodiments herein, the extraneous water source is or includes well water, produced water, tap water, river water, lake water, sea water, brine, industrial waste water, greywater, farm animal waste water, road runoff water, overflow water from a stream, river, or lake, cooling tower discharge water, or any partially or completely treated water source derived therefrom.

In any one or more fifth embodiments herein, the extraneous water source retained by the surface water reservoir applies a hydrostatic pressure of about 0.1 psi to about 2000 psi to at least one point on the contacted portion of the upper surface of the sealed subterranean formation or the subterranean fluid storage reservoir, for example 0.1 psi to 2000 psi, or 1 psi to 2000 psi, or 5 psi to 2000 psi, or 10 psi to 2000 psi, or 50 psi to 2000 psi, or 100 psi to 2000 psi, or 200 psi to 2000 psi, or 300 psi to 2000 psi, or 400 psi to 2000 psi, or 500 psi to 2000 psi, or 600 psi to 2000 psi, or 700 psi to 2000 psi, or 800 psi to 2000 psi, or 900 psi to 2000 psi, or 1000 psi to 2000 psi, or 1200 psi to 2000 psi, or 1400 psi to 2000 psi, or 1600 psi to 2000 psi, or 1800 psi to 2000 psi, or 0.1 psi to 1800 psi, or 0.1 psi to 1600 psi, or 0.1 psi to 1400 psi, or 0.1 psi to 1200 psi, or 0.1 psi to 1000 psi, or 0.1 psi to 900 psi, or 0.1 psi to 800 psi, or 0.1 psi to 700 psi, or 0.1 psi to 600 psi, or 0.1 psi to 500 psi, or 0.1 psi to 400 psi, or 0.1 psi to 300 psi, or 0.1 psi to 2300 psi, or 0.1 psi to 100 psi, or 0.1 psi to 90 psi, or 0.1 psi to 80 psi, or 0.1 psi to 70 psi, or 0.1 psi to 60 psi, or 0.1 psi to 50 psi, or 0.1 psi to 40 psi, or 0.1 psi to 30 psi, or 0.1 psi to 20 psi, or 0.1 psi to 10 psi, or 0.1 psi to 1 psi, or 1 psi to 10 psi, or 10 psi to 20 psi, or 20 psi to 30 psi, or 30 psi to 40 psi, or 40 psi to 50 psi, or 50 psi to 60 psi, ot 60 psi to 70 psi, or 70 psi to 80 psi, or 80 psi to 90 psi, or 90 psi to 100 psi, or 100 psi to 200 psi, or 200 psi to 400 psi, or 400 psi to 600 psi, or 600 psi to 800 psi, or 800 psi to 1000 psi, or 1000 psi to 1200 psi, or 1200 psi to 1400 psi, or 1400 psi to 1600 psi, or 1600 to 1800 psi to at least one point on the upper surface of the sealed subterranean formation or subterranean fluid storage reservoir, wherein the extraneous water source is retained or substantially retained thereon.

### Sixth Embodiments

In accordance with the foregoing first through fifth embodiments, also disclosed herein are sixth embodiments, which are kits for forming sealed subterranean formations, subterranean fluid storage reservoirs, and/or surface water reservoirs in accordance with any one or more of first through fifth embodiments herein. In any one or more first kits of the sixth embodiments, first and second containers are provided, wherein the first container contents comprise, consists essentially of, or consist of one or more silicate salts, and optionally a solvent such as water; and the second container contents comprise, consists essentially of, or consist of a reactive silane mixture, that is, a mixture of an epoxysilane and an aminosilane, and optionally a solvent such as any one or more of the solvents disclosed in first embodiments above.

In any one or more first kits of sixth embodiments herein, the epoxysilane and the aminosilane contents of the second container are provided in amounts therein such that the molar ratio of epoxy groups to amine groups within the second container is between about 2:1 and about 1:2, and in embodiments is about 1:1.

In some first kits of the sixth embodiments, in addition to first and second containers, a third container is provided, wherein the third container contents comprise, consists essentially of, or consist of CaCl₂, CaO, or an acid; and optionally water.

In some first kits of the sixth embodiments, in addition to first and second containers and optional third container, a fourth container is provided, wherein the fourth container contents comprise, consist essentially of, or consist of a packing composition in accordance with first embodiments herein, or a component thereof that is a metal oxide particulate. In embodiments, the packing composition of the fourth container comprises, consists essentially of, or consists of sand having a particle size corresponding to 10 mesh to 500 mesh.

In some first kits of the sixth embodiments, in addition to first and second containers, both third and fourth containers are provided, wherein each of the first, second, third, and fourth containers include the contents as described in sixth embodiments hereinabove.

In some sixth embodiments herein, the epoxysilane and the aminosilane are provided in separate containers, and not as a mixture thereof. Accordingly, in some second kits of sixth embodiments, first, fifth, and sixth containers are provided, wherein the first container contents comprise, consists essentially of, or consist of one or more silicate salts, and optionally a solvent such as water; the fifth container contents comprise, consists essentially of, or consist of an epoxysilane, and optionally a solvent such as any one or more of the solvents disclosed in first embodiments above; and the sixth container contents comprise, consists essentially of, or consist of an aminosilane, and optionally a solvent such as any one or more of the solvents disclosed above.

In some second kits of sixth embodiments herein, the epoxysilane contents of the fifth container and the aminosilane contents of the sixth container are provided in amounts such that the molar ratio of epoxy groups provided by the epoxysilane in the fifth container to the amine groups of the aminosilane in the sixth container is between 2:1 and 1:2, and in embodiments is about 1:1.

In some second kits of sixth embodiments, a third container is further provided, wherein the third container contents comprise, consists essentially of, or consist of CaCl₂, CaO, or an acid; and optionally water. In some second kits of sixth embodiments, a fourth container is further provided, wherein the fourth container contents comprise, consist essentially of, or consist of a packing composition or a component thereof that is a metal oxide particulate. In some second kits of sixth embodiments, in addition to first, fifth, and sixth containers, both third and fourth containers are provided.

### Seventh Embodiments

In accordance with the foregoing first through sixth embodiments, also disclosed herein are seventh embodiments that are partially sealed subterranean reservoirs. The partially sealed subterranean reservoirs are formed using the methods of forming treated subterranean formations of first embodiments herein, further wherein a reactive composition is formed in situ or applied directly to one or more selected locations within the subterranean reservoir to seal only the portions of the reservoir located at, or fluidly connected to the selected locations. Accordingly, a partially sealed subterranean reservoir of seventh embodiments herein does not prevent fluid entry into the reservoir altogether; rather, the selectively sealed portions of the partially sealed subterranean reservoir partially or completely prevent fluids from entering one or more selected portions of the reservoir, and also direct all or a substantial portion of an injected flow of fluid into one or more desired areas of the reservoir for fluid circulation and recirculation.

Accordingly, in seventh embodiments, a partially sealed subterranean reservoir obtains a directed flow of fluids therein, such that injecting fluids into a partially and selectively sealed subterranean reservoir of seventh embodiments obtains a more efficient or controlled pathway for crude oil recovery and/or avoids loss of fluids into areas of the reservoir that resist recirculation of injected fluids and instead drain a portion of an injected fluid away from the reservoir where they cannot be recovered. Accordingly, in seventh embodiments, a partially sealed subterranean reservoir is a controlled flow reservoir, or a directed flow reservoir, that reduces or even eliminates loss of circulation materials during injection and/or recovery of crude oil products.

### Experimental Section

Formulations A-E, shown in Table 1 were formed by admixing one or more of 3-glycidoxypropyltrimethoxysilane, or GPTMS; 3-aminopropyltriethoxysilane, or APTES; sodium silicate (40 wt %); calcium chloride; and a copolymer of acrylamide (AM) and 2-acrylamido-2-methylpropane sulfonic acid (AMPS); and then immediately pouring 80 g of each admixture into a fluid loss testing cell with 250 g of 100 mesh sand, taking care to distribute the admixture evenly across the sand. Each test cell containing an admixture combined with sand was allowed to sit and undisturbed in ambient laboratory conditions overnight to form a cured sandpack. After cure, 300 g of water was poured on the cured sand pack and pressure was gradually increased to 1000 psi to observe the breakthrough and fluid loss. Formulations D and E, including GPTMS, APTES, sodium silicate, and calcium chloride, provided cured sandpacks in accordance with the methods, uses, and compositions described in first through fifth embodiments herein.

TABLE 1
Components of Formulations A-E. Weight percentages
are weight percentage of the listed formulation.

| | | | Sodium | AM/AMPS | |
|---|---|---|---|---|---|
| Formu- | GPTMS, | APTES, | silicate, | Copolymer, | CaCl₂•2H₂O, |
| lation | wt % | wt % | wt % | ppm by wt | wt % |
| A | 0 | 0 | 15 | 0 | 1.5 |
| B | 5 | 5 | 0 | 0 | 0.5 |
| C | 5 | 5 | 0 | 3000 | 0.5 |
| D | 5 | 5 | 5 | 0 | 0.5 |
| E | 5 | 5 | 5 | 3000 | 0.5 |

The cured sandpacks were removed from the test cells and analyzed for appearance and consistency, and pressure and shear force were physically applied using a metal spatula to determine if the cured sandpack could be destroyed or degraded significantly.

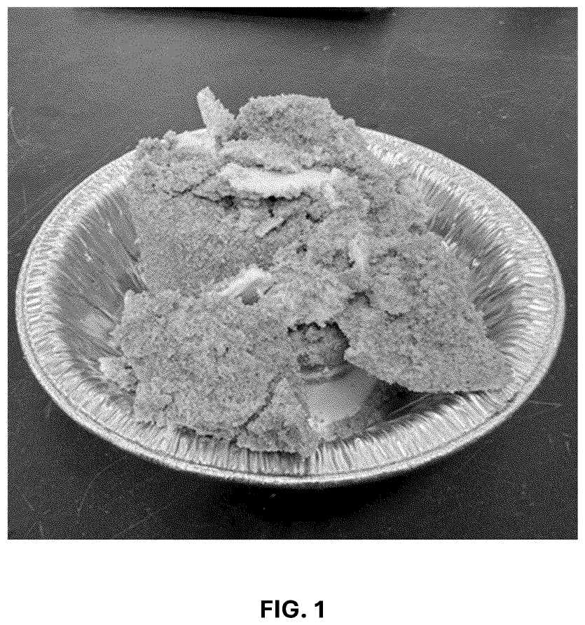

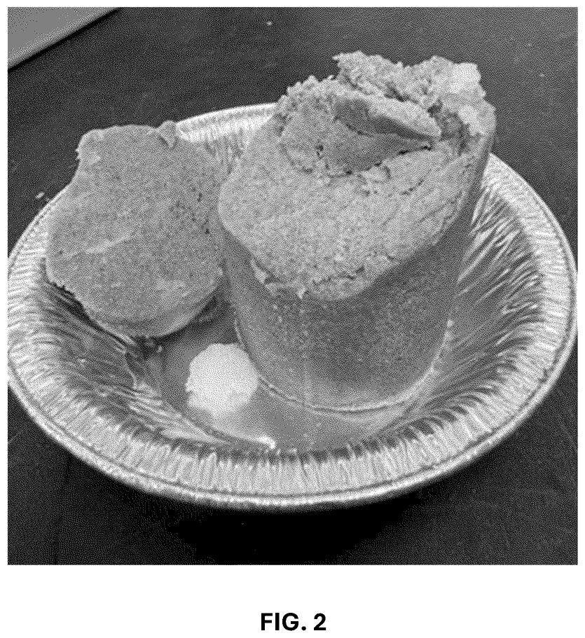

No sand consolidation was observed in the Formulation A sandpack (that is, the sandpack formed by adding Formulation A and curing): the Formulation A sandpack crumbled upon removal from the test cell. The remains of the Formulation A sandpack after removal from the test cell is shown in FIG. 1. The Formulation B sandpack was fully consolidated, that is, all the sand from the test cell was part of a single solid plug upon removal from the test cell. Further, the Formulation B sandpack was rubbery and flexible when pressed and sheared with the metal spatula. However, the Formulation B sandpack was easily sliced apart, for example with a laboratory spatula, after the curing period had passed; and therefore lacks sufficient toughness to effectively seal a subterranean formation against emanants including subterranean water and/or gases. The remains of the Formulation B sandpack after slicing is shown in FIG. 2.

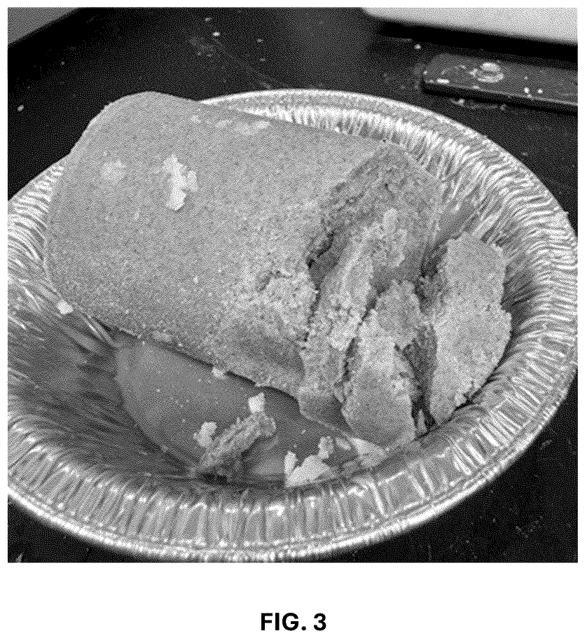

The Formulation C sandpack was observed to have the same properties as the Formulation B sandpack. The remains of the Formulation C sandpack after slicing is shown in FIG. 3.

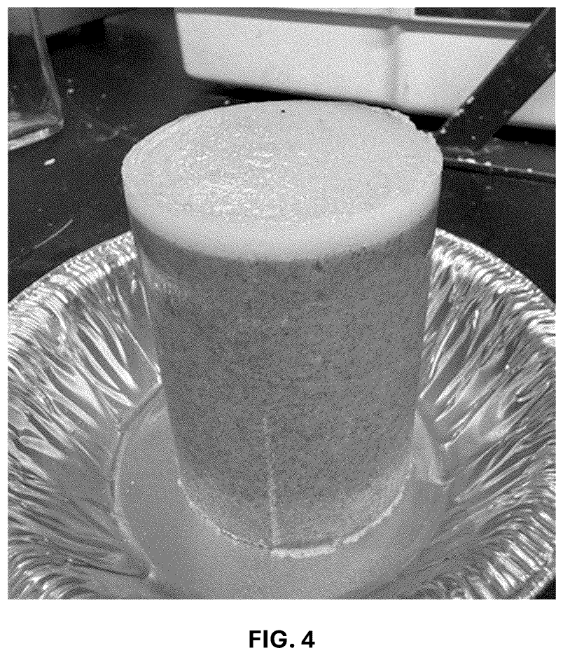

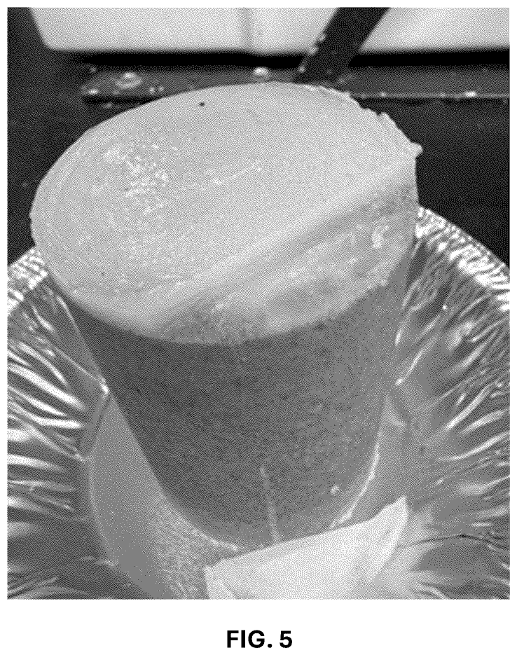

In sharp contrast to comparative sandpacks formed using Formulations A-C, both the Formulation D and E sandpacks were found to be fully consolidated, and could not be destroyed or degraded manually using a metal spatula. The Formulation D and E sandpacks after efforts to destroy or degrade them using the spatula are shown in FIGS. 4 and 5, respectively. The Formulation D and E sandpacks completely resisted all manual efforts to affect the integrity of the sandpack or even mar their surfaces.

Rating the sandpacks formed with Formulations A-E in terms of relative hardness when manipulated with the metal spatula, the hardness of the sandpacks increased from Formulation A, which provided no consolidation, to Formulations B and C, which provided some resistance to the metal spatula, to Formulations D and E, which could not be manipulated or degraded manually using the metal spatula.

The fluid loss rate of the consolidated sandpacks, that is, the Formulation B, C, D, and E sandpacks, were compared by subjecting each of the sandpacks to the following Fluid Loss Test, which is used to determine a rate of fluid loss in cc/minute over a range of applied pressure. Results of the fluid loss rate tests are shown in Table 2.

### Fluid Loss Test

Add 80 g (cc) of a selected Formulation A-E to a 500 mL test cell equipped for containing a sample under a set pressure, and having a drain valve on the bottom of the cell for draining liquids, and a gas inlet at the top of the cell for applying a pressurized gas to the cell. Then load the test cell with 250 g of 100 mesh sand by carefully and completely packing the sand by hand to distribute the Formulation throughout, and eliminate air pockets/bridging of the sand particles. Drain excess fluid from the test cell, ensuring that at least 1 pore volume of the fluid remains inside. Then seal the test cell, apply 30 psi nitrogen gas to the cell through the gas inlet, and allow the cell sit undisturbed under pressure for 22 hours.

After the 22 hours, open the test cell and add 300 g of water or brine to the cell. Apply a selected pressure to the cell, start a timer, and open the valve at the bottom, and collect the fluid; measure the volume of fluid that passes through the valve in the measured amount of time to calculate the fluid loss rate.

TABLE 2
Fluid loss rate, cc/minute, at the indicated applied pressure,
for the sandpacks formed using Formulations B, C, D, and E.

| | |
|---|---|
| Applied | Fluid loss rate, cc/minute |
| Pressure, | for sandpack formed using Formulation: |

| psi | B | C | D | E |
|---|---|---|---|---|
| 100 | 3.2 | 4.1 | 0 | 0 |
| 200 | 7.7 | 11 | 0 | 0 |
| 300 | 13 | 25 | 0.1 | 0 |
| 400 | 28 | 74 | 0.2 | 0 |
| 500 | 50 | 132 | 0.3 | 0.2 |
| 600 | 88 | 168 | 0.4 | 0.3 |
| 700 | 117 | 195 | 0.9 | 6.3 |
| 800 | 156 | — | 9.5 | 25 |
| 900 | — | — | 54 | 66 |
| 1000 | — | — | 120 | 143 |

The foregoing detailed description has been given for clarity of understanding only. No unnecessary limitations are to be understood therefrom. The invention is not limited to the exact details shown and described, for variations obvious to one skilled in the art will be included within the invention defined by the claims.

What is claimed is:

1. A method of treating a subterranean formation, the method comprising:
packing at least a portion of the subterranean formation with a packing composition to form a packed subterranean formation; and
applying a sealing composition to the packed subterranean formation to form a treated subterranean formation,
wherein the packing composition comprises one or more metal oxide particulates, and the sealing composition comprises one or more silicate salts and a reactive silane mixture.

2. The method of claim 1 wherein the applying comprises spraying, pumping, or pouring the sealing composition onto the packed subterranean formation or injecting the sealing composition into the packed subterranean formation, optionally wherein the applying further comprises adding a pressure to the sealing composition during the applying.

3. The method of claim 1 wherein the proportion by weight of the packing composition to the sealing composition is about 2:1 to about 100:1, and/or wherein the proportion by weight of the metal oxide particulate to the sealing composition is about 2:1 to about 100:1.

4. The method of claim 1 wherein the one or more metal oxide particulates comprises a silica, an alumina, or any combination thereof, optionally wherein one or more metal oxide particulates comprises a sand having a particle size of about 10 mesh to about 500 mesh.

5. The method of claim 1 further comprising allowing a curing period to pass after forming the treated subterranean formation, wherein the treated subterranean formation becomes a sealed subterranean formation after the curing period has passed, further wherein the curing period is between about 1 minute and about 5 days.

6. The method of claim 5 further comprising adding a water source to the sealed subterranean formation, wherein the water source contacts at least a portion of an upper surface of the sealed subterranean formation, optionally wherein the amount of the water source added to the sealed subterranean formation corresponds to a hydrostatic pressure of about 0.1 psi to about 2000 psi on at least a portion of the upper surface of the sealed subterranean formation.

7. The method of claim 1 wherein the sealing composition further comprises a solvent, wherein the solvent is present at about 1% to about 99% by weight of the sealing composition, and wherein the solvent optionally comprises water.

8. The method of claim 1 wherein the reactive silane mixture comprises one or more epoxysilanes and one or more aminosilanes, and/or wherein the one or more silicate salts comprises sodium silicate.

9. The method of claim 8 wherein the molar ratio of epoxy groups to amino groups in the reactive silane mixture is about 2:1 to about 1:2; and/or wherein the proportion by weight of the one or more epoxysilanes to the one or more aminosilanes is about 5:1 to about 1:5; and/or wherein the proportion by weight of the one or more silicate salts to the reactive silane mixture is about 5:1 to about 1:5.

10. A method of treating a subterranean formation, the method comprising:
mixing a packing composition with a sealing composition to form a reactive composition; and
packing at least a portion of the subterranean formation with the reactive composition to form a treated subterranean formation,
wherein the packing composition comprises one or more metal oxide particulates, and the sealing composition comprises one or more silicate salts and a reactive silane mixture.

11. A reactive composition disposed within a subterranean formation or a portion thereof, the reactive composition comprising:
a. a packing composition comprising one or more metal oxide particulates having a particle size of about 10 mesh to about 500 mesh; and
b. a sealing composition comprising
i. one or more silicate salts,
ii. one or more epoxysilanes, and
iii. one or more aminosilanes.

12. The reactive composition of claim 11 wherein the subterranean formation is a drilled formation or a fractured formation.

13. The reactive composition of claim 11 wherein the one or more metal oxide particulates comprises a silica, an alumina, or any combination thereof.

14. The reactive composition of claim 11 wherein the one or more epoxysilanes comprises a 3-glycidoxypropyltrialkoxysilane and/or wherein the one or more aminosilanes comprises a 3-(2-aminoethylamino)propyltrialkoxysilane, an N-(2-aminoethyl)-3-aminopropyltrialkoxysilane, and/or a (3-aminopropyl)trialkoxysilane.

15. The reactive composition of claim 11 comprising a molar ratio of epoxy groups to amine groups in the reactive composition of about 2:1 to about 1:2; and/or a proportion by weight of the one or more epoxysilanes to the one or more aminosilanes in the reactive composition of about 5:1 to about 1:5; and/or a proportion by weight of the one or more silicate salts to the combination of the epoxysilane and the aminosilane in the reactive composition of about 5:1 to about 1:5.

16. The reactive composition of claim 11 further comprising a curing agent comprising one or more of: CaCl₂, CaO, or an acid comprising sulfuric acid, hydrochloric acid, sulfamic acid, nitric acid, formic acid, acetic acid, toluenesulfonic acid, citric acid, or any combination thereof.

17. The reactive composition of claim 11 further comprising one or more polymers, the one or more polymers comprising one or more polyacrylamides, one or more partially hydrolyzed polyacrylamides, one or more polymethylolacrylamides, one or more polyalkylene glycols, one or more polyvinyl alcohols, one or more polyvinyl acetates, one or more derivatives of any of these, one or more copolymers of any of these, or any mixture of two or more thereof; and/or the one or more polymers comprising one or more guar gums, one or more locust bean gums, one or more xanthan gums, one or more celluloses, one or more hemicelluloses, one or more starches, one or more lignins, one or more hydroxymethylcelluloses, one or more hydroxyethylcelluloses, one or more crosslinked versions of these, derivatives of these, or any mixture of two or more thereof.

18. A sealed subterranean formation formed by curing the reactive composition of claim 11.

19. The sealed subterranean formation of claim 18 further comprising one or more extraneous fluids retained therein, optionally wherein the one or more extraneous fluids comprises a gas.

20. The sealed subterranean formation of claim 18 further comprising an extraneous water source disposed on top of the sealed subterranean formation, wherein the extraneous water source contacts at least a portion of an upper surface of the sealed subterranean formation.

21. The sealed subterranean formation of claim 18 wherein the extraneous water source obtains a hydrostatic pressure of about 0.1 psi to about 2000 psi applied to at least one point on the upper surface of the sealed subterranean formation.

22. A partially sealed subterranean formation formed by curing the reactive composition of claim 11 disposed within a portion of the subterranean formation.
